(19) United States
(12) Patent Application Publication
(10) Pub. No.: US 2018/0293315 A1
(43) Pub. Date: Oct. 11, 2018

(54) DEVICE FOR MULTIPLE CONDITION SEARCH BASED ON KNOWLEDGE POINTS

(71) Applicant: ZHENGFANG MA, SHANGHAI (CN)

(72) Inventors: HONG TAN, SHANGHAI (CN); GUANGHUA JIANG, SHANGHAI (CN)

(73) Assignee: ZHENGFANG MA, SHANGHAI (CN)

(21) Appl. No.: 15/740,959

(22) PCT Filed: Aug. 11, 2016
(86) PCT No.: PCT/CN2016/094596

§ 371 Date: Jun. 9, 2018

(30) Foreign Application Priority Data
Aug. 21, 2015 (CN) 201510519034.6

(51) Int. Cl. G06F 17/30

(52) U.S. Cl. CPC G06F 17/30864; G06F 17/30554

(57) ABSTRACT

A knowledge point-based multi-criteria search apparatus, which retrieves a relationship between knowledge points. A server stores knowledge point structures constructed by users, a network terminal receives a multi-criteria search request of a user, and the server performs search processing for the search request and feeds back a processing result to the network terminal for displaying. This includes entering names of two knowledge points, and searching for a relationship between the two knowledge points; or entering a name of a single knowledge point and a user name to which a knowledge point structure belongs, and searching for content of the knowledge point in the knowledge point structure corresponding to the user name; or entering names of two knowledge points and a user name to which a knowledge point structure belongs, and searching for a relationship between the two knowledge points in the knowledge point structure under the user name.

### BACKGROUND OF THE PRESENT INVENTION

### Field of Invention

The present invention relates to search systems, and in particular, to a network apparatus that performs a search for a relationship between knowledge points in a knowledge point structure.

### Description of Related Arts

During online learning, knowledge is often categorized. The elementary unit in an entire knowledge system is referred to as a knowledge point. For example, in Baidupedia, a knowledge point is also referred to as a vocabulary entry. A logical relationship may exist between a plurality of knowledge points, for example, a parallel relationship, an inclusion relationship, or a causal relationship.

Conventional online learning is knowledge point-based learning. However, knowledge points are basically displayed in a text list form. For example, in Baidupedia, a user obtains a related vocabulary entry by inputting a search word, and Baidupedia displays content of the vocabulary entry, information about an editor, and the like on a page. In addition, a vocabulary entry associated with the vocabulary entry is further displayed. This associated vocabulary entry generally appears in the content of the vocabulary entry, and is provided by using a network link. The user clicks this link to enter the vocabulary entry corresponding to the link.

However, such search manner as the one in Baidupedia has the following disadvantages:

(1) Association between vocabulary entries in Baidupedia is a very weak connection, and basically there is no strong logical relationship, because this association is only a link that is established when another vocabulary entry appears in an explanation of a current vocabulary entry. If the user needs to specially learn a type of knowledge, the user cannot perform learning in a manner such as Baidupedia, because there is no logical relationship between vocabulary entries that need to be learned. This does not help the user construct a knowledge system. Therefore, a Baidupedia-based search is generally a search for content of a vocabulary entry, and cannot be a search for a relationship existing between two vocabulary entries.

(2) Most explanations of vocabulary entries and relationships between vocabulary entries are officially defined by Baidupedia, and the user can accept only the official definitions of the vocabulary entries provided by Baidupedia.

### SUMMARY OF THE PRESENT INVENTION

The following provides brief overviews of one or more aspects, to provide basic understandings about these aspects. The overviews are not detailed comprehensive views of all conceived aspects, and are neither intended to identify key or decisive elements of all the aspects, nor intended to define a range of any aspect or all the aspects. A unique object thereof is to provide some concepts of the one or more aspects in a simplified form as a foreword to a more detailed description that is provided later on.

An object of the present invention is to resolve the foregoing problem. The present invention provides a knowledge point-based multi-criteria search apparatus, to efficiently retrieve a relationship between knowledge points, and to perform an oriented search for a definition of a relationship between knowledge points or content of a knowledge point provided by an individual or an institution.

A technical solution of the present invention is: the present invention discloses a knowledge point-based multi-criteria search apparatus, comprising a network terminal and a server, where

the network terminal comprises:

a first search request input module, receiving a first knowledge point entered by a user;

a second search request input module, receiving a second knowledge point entered by the user;

a first transmission module, transmitting data to the server; and

a display module, displaying a search result that is from the server; and

the server comprises:

a second transmission module, transmitting data to the network terminal;

a knowledge point storage module, storing knowledge point structures constructed by users; and

a search processing module, searching, based on the first knowledge point and the second knowledge point that are uploaded by the network terminal, the knowledge point structures that are constructed by the users and that are stored in the knowledge point storage module for a relationship between the first knowledge point and the second knowledge point, and backhauling the search result to the network terminal by using the second transmission module.

According to an embodiment of the knowledge point-based multi-criteria search apparatus consistent with the present invention, content of the search result displayed by the display module comprises: a name of the relationship that is between the first knowledge point and the second knowledge point and that is in all the knowledge point structures, content that is of the first knowledge point and that is in all the knowledge point structures, and content that is of the second knowledge point and that is in all the knowledge point structures.

According to an embodiment of the knowledge point-based multi-criteria search apparatus consistent with the present invention, the network terminal further comprises:

a third search request input module, receiving a user name that is entered by the user and to which a knowledge point structure belongs; and

a search processing module, searching, based on the first knowledge point and the second knowledge point that are uploaded by the network terminal and the user name to which the knowledge point structure belongs, the knowledge point structure corresponding to the user name for the relationship between the first knowledge point and the second knowledge point, and backhauling the search result to the network terminal by using the second transmission module.

According to an embodiment of the knowledge point-based multi-criteria search apparatus consistent with the present invention, content of the search result displayed by the display module comprises: a name of the relationship that is between the first knowledge point and the second knowledge point and that is in the knowledge point structure corresponding to the user name, content that is of the first knowledge point and that is in the knowledge point structure corresponding to the user name, and content that is of the second knowledge point and that is in the knowledge point structure corresponding to the user name.

According to an embodiment of the knowledge point-based multi-criteria search apparatus consistent with the present invention, the search processing module further comprises:

a search result sequencing unit, performing sequencing processing on the search result.

The present invention further discloses a knowledge point-based multi-criteria search apparatus, comprising a network terminal and a server, where the network terminal comprises:

a first search request input module, receiving a knowledge point entered by a user;

a second search request input module, receiving a user name that is entered by the user and to which a knowledge point structure belongs;

a first transmission module, transmitting data to the server; and

a display module, displaying a search result that is from the server; and

the server comprises:

a second transmission module, transmitting data to the network terminal;

a knowledge point storage module, storing knowledge point structures constructed by users; and

a search processing module, searching, based on the knowledge point uploaded by the network terminal, the knowledge point structure that is constructed under the user name and that is stored in the knowledge point storage module for content of the knowledge point, and backhauling the search result to the network terminal by using the second transmission module.

The present invention additionally discloses a knowledge point-based search apparatus, comprising a network terminal and a server, where the network terminal comprises:

a search request input module, receiving a user name that is entered by a user and to which a knowledge point structure belongs;

a first transmission module, transmitting data to the server; and

a display module, displaying a search result that is from the server; and

the server comprises:

a second transmission module, transmitting data to the network terminal;

a knowledge point storage module, storing knowledge point structures constructed by users; and

a search processing module, searching the knowledge point structure constructed under the user name, and backhauling the search result to the network terminal by using the second transmission module.

According to an embodiment of the knowledge point-based search apparatus consistent with the present invention, the search processing module further comprises:

a local structure extraction unit, extracting a local area in the knowledge point structure as the search result according to a preset rule, and backhauling the search result to the network terminal by using the second transmission module.

Compared with the prior art, the present invention has the following beneficial effects: in the present invention, knowledge point structures constructed by users (comprising individuals and institutions) are stored on a server, a multi-criteria search request of a user is received on a network terminal, and search processing is performed on the server for the search request and a processing result is fed back to the network terminal for displaying. This comprises entering names of two knowledge points, and searching for a relationship between the two knowledge points; or entering a name of a single knowledge point and a user name (comprising that of an individual or an institution) to which a knowledge point structure belongs, and performing a directed search for content of the knowledge point in the knowledge point structure corresponding to the user name; or entering names of two knowledge points and a user name to which a knowledge point structure belongs, and performing a directed search for a relationship between the two knowledge points in the knowledge point structure corresponding to the user name; or entering a user name to which a knowledge point structure belongs, and searching an entire knowledge point structure corresponding to the user name or a local area thereof.

### BRIEF DESCRIPTION OF THE DRAWINGS

FIG. 1 is a schematic diagram of a first embodiment of a knowledge point-based multi-criteria search apparatus consistent with the present invention.

FIG. 2 is a schematic diagram of a second embodiment of a knowledge point-based multi-criteria search apparatus consistent with the present invention.

FIG. 3 is a schematic diagram of a third embodiment of a knowledge point-based multi-criteria search apparatus consistent with the present invention.

FIG. 4 is a schematic diagram of a preferred embodiment of a knowledge point-based search apparatus consistent with the present invention.

### DETAILED DESCRIPTION OF THE PREFERRED EMBODIMENTS

After detailed descriptions of the embodiments of the present disclosure are read with reference to the following accompanying drawings, the foregoing characteristics and advantages consistent with the present invention can be better understood. In the accompanying drawings, components are not necessarily drawn proportionally, and components having similar related features or characteristics may have same or similar reference numerals.

### First Embodiment of a Knowledge Point-Based Multi-Criteria Search Apparatus

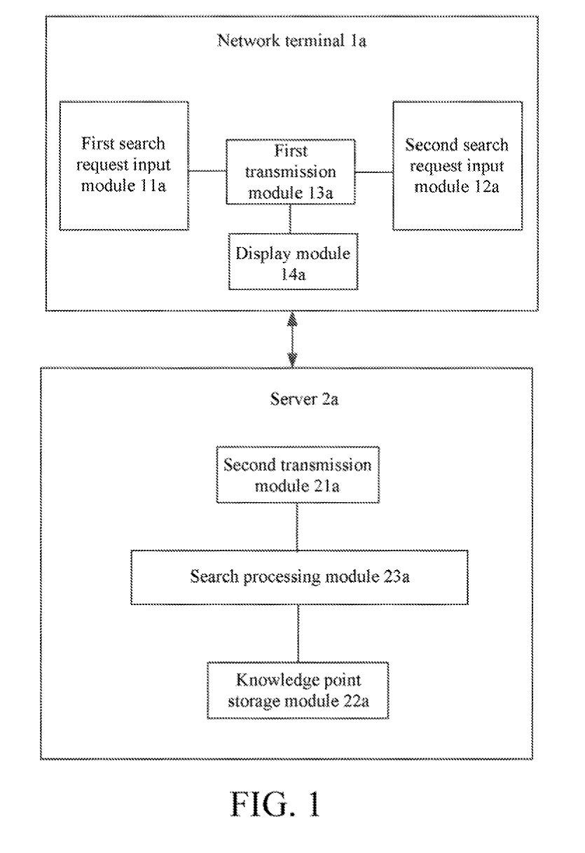

FIG. 1 shows the first embodiment of the knowledge point-based multi-criteria search apparatus consistent with the present invention. Referring to FIG. 1, the knowledge point-based multi-criteria search apparatus in this embodiment comprises: a network terminal 1a and a server 2a.

The network terminal 1a comprises a first search request input module 11a, a second search request input module 12a, a first transmission module 13a, and a display module 14a.

The first search request input module 11a receives a first knowledge point entered by a user. A specific implementation may be displaying a search bar on a display screen of the network terminal, for the user to enter the first knowledge point. The second search request input module 12a receives a second knowledge point entered by the user. A specific implementation may be displaying another search bar on the display screen of the network terminal, for the user to enter the second knowledge point. A search request for a relationship between the first knowledge point and the second knowledge point entered by the user is uploaded to the server 2a by the first transmission module 13a.

The server 2a comprises a second transmission module 21a, a knowledge point storage module 22a, and a search processing module 23a. The server 2a receives the search request from the network terminal by using the second transmission module 21a, and the knowledge point storage module 22a stores knowledge point structures constructed by users. The knowledge point storage module 22a stores a category, a structural relationship, a label, and content of a knowledge point. The category of the knowledge point refers to a category defined for the knowledge point by an editor of the knowledge point. For example, a user A defines“Belt and Road” into an “economy” category during editing, but a user B may define it into a “politics” category during editing. Different users have different understandings about a same knowledge point, and therefore may define it into different categories.

The label of the knowledge point is similar to a name of the knowledge point. For example, “Belt and Road” is a label of this knowledge point. The content of the knowledge point is a specific definition of the knowledge point. For example, a specific meaning of the Belt and Road is content under the label of “Belt and Road”.

The structural relationship of the knowledge point refers to a logical relationship between knowledge points, and this logical relationship may be preferably expressed by using a data structure in a tree form. A hyponymy relationship between knowledge points is expressed by using parent and child nodes, and a parallel relationship between knowledge points is expressed by using brother nodes. For example, a parent node of “Belt and Road” is “National Strategy”, child nodes of “Belt and Road” are “Silk Road Economic Belt”, “Maritime Silk Road”, and “Asian Infrastructure Investment Bank”, and brother nodes of “Belt and Road” are “Beijing-Tianjin-HebeiIntegration”, “Yangtze River Economic Belt”, “Free Trade Zone”, “Western Region Development”, “Revitalization of the Northeast”, and the like.

When an editor enters a knowledge point, in addition to content of the knowledge point, the editor further enters a relationship between the knowledge point and other knowledge points. For example, for a knowledge point A currently entered and an existing knowledge point B, a relationship between the knowledge point A and the knowledge point B may be entered when the knowledge point A is entered, which may be classified into: no relationship exists between A and B, or a parallel relationship exists between A and B. If a parallel relationship exists between A and B, it indicates that granularities of the knowledge points A and B are the same. The parallel relationship may be further classified into three categories: a causal relationship, no causal relationship but with a learning sequence, and no causal relationship and no learning sequence.

Similarly, no relationship or a parallel relationship (the parallel relationship is further classified into three categories: a causal relationship, no causal relationship but with a learning sequence, and no causal relationship and no learning sequence) exists between the knowledge point A currently entered and a plurality of existing knowledge points B, C, D, . . . . In addition, there is an implication/affiliation relationship between the knowledge point A and the plurality of existing knowledge points B, C, D, . . . .

The search processing module 23a searches the knowledge point structures constructed by the users and stored in the knowledge point storage module 22a for relationships between the first knowledge point and the second knowledge point, and returns a search result to the network terminal 1a by using the second transmission module 21a.

The display module 14a of the network terminal 1a displays the search result from the server 2a. If corresponding relationships between the first knowledge point and the second knowledge point are retrieved, the display module 14a displays the following contents: names of the relationships between the first knowledge point and the second knowledge point in all the knowledge point structures, contents of the first knowledge point in all the knowledge point structures, and contents of the second knowledge point in all the knowledge point structures. For example, if three relationships between the knowledge point A and the knowledge point B are retrieved which respectively belong to a user 1, a user 2, and a user 3, the displayed contents are: a relationship a between the knowledge point A and the knowledge point B is embodied in a knowledge point structure of the user 1, a relationship b between the knowledge point A and the knowledge point B is embodied in a knowledge point structure of the user 2, and a relationship c between the knowledge point A and the knowledge point B is embodied in a knowledge point structure of the user 3.

Preferably, a search result sequencing unit configured to perform sequencing processing on the search result may be further disposed in the search processing module of the server, for example, perform sequencing according to the number of searches or the number of clicks.

After reading the search result of the relationship between the knowledge points on the screen of the network terminal, the user may click the name of the relationship, to obtain content of the knowledge points defined in the relationship. For example, if the user clicks the relationship b, content of the knowledge point A and the knowledge point B in the relationship b defined by the user 2 is further displayed.

### Second Embodiment of a Knowledge Point-Based Multi-Criteria Search Apparatus

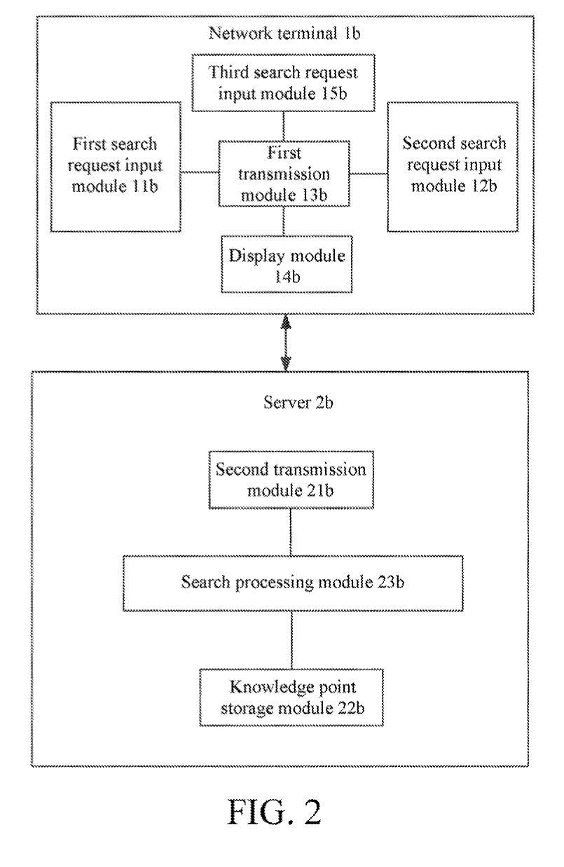

FIG. 2 shows the second embodiment of the knowledge point-based multi-criteria search apparatus consistent with the present invention. Referring to FIG. 2, the knowledge point-based multi-criteria search apparatus in this embodiment comprises: a network terminal 1b and a server 2b.

The network terminal 1b comprises a first search request input module 11b, a second search request input module 12b, a third search request input module 15b, a first transmission module 13b, and a display module 14b.

The first search request input module 11b receives a first knowledge point entered by a user. A specific implementation may be displaying a search bar on a display screen of the network terminal, for the user to enter the first knowledge point. The second search request input module 12b receives a second knowledge point entered by the user. A specific implementation may be displaying another search bar on the display screen of the network terminal, for the user to enter the second knowledge point. The third search request input module 13b receives a user name entered by the user to which a knowledge point structure belongs. A specific implementation may be displaying a third search bar on the display screen of the network terminal, for the user to enter a user name that the user wants to search. A search request for a relationship between the first knowledge point and the second knowledge point entered by the user in the knowledge point structure corresponding to the user name is uploaded to the server 2b by using the first transmission module 13b.

The server 2b comprises a second transmission module 21b, a knowledge point storage module 22b, and a search processing module 23b. The server 2b receives the search request from the network terminal by using the second transmission module 21b, and the knowledge point storage module 22b stores knowledge point structures constructed by users. The knowledge point storage module 22b stores a category, a structural relationship, a label, and content of a knowledge point. The category of the knowledge point refers to a category defined for the knowledge point by an editor of the knowledge point. For example, a user A defines“Belt and Road” into an “economy” category during editing, but a user B may define it into a “politics” category during editing. Different users have different understandings about a same knowledge point, and therefore may define it into different categories.

The label of the knowledge point is similar to a name of the knowledge point. For example, “Belt and Road” is a label of this knowledge point. The content of the knowledge point is a specific definition of the knowledge point. For example, a specific meaning of the Belt and Road is content under the label of “Belt and Road”.

The structural relationship of the knowledge point refers to a logical relationship between knowledge points, and this logical relationship may be preferably expressed by using a data structure in a tree form. A hyponymy relationship between knowledge points is expressed by using parent and child nodes, and a parallel relationship between knowledge points is expressed by using brother nodes. For example, a parent node of “Belt and Road” is “National Strategy”, child nodes of “Belt and Road” are “Silk Road Economic Belt”, “Maritime Silk Road”, and “Asian Infrastructure Investment Bank”, and brother nodes of “Belt and Road” are “Beijing-Tianjin-HebeiIntegration”, “Yangtze River Economic Belt”, “Free Trade Zone”, “Western Region Development”, “Revitalization of the Northeast”, and the like.

When an editor enters a knowledge point, in addition to content of the knowledge point, the editor further enters a relationship between the knowledge point and other knowledge points. For example, for a knowledge point A currently entered and an existing knowledge point B, a relationship between the knowledge point A and the knowledge point B may be entered when the knowledge point A is entered, which may be classified into: no relationship exists between A and B, or a parallel relationship exists between A and B. If a parallel relationship exists between A and B, it indicates that granularities of the knowledge points A and B are the same. The parallel relationship may be further classified into three categories: a causal relationship, no causal relationship but with a learning sequence, and no causal relationship and no learning sequence.

Similarly, no relationship or a parallel relationship (the parallel relationship is further classified into three categories: a causal relationship, no causal relationship but with a learning sequence, and no causal relationship and no learning sequence) exists between the knowledge point A currently entered and a plurality of existing knowledge points B, C, D, . . . . In addition, there is an implication/affiliation relationship between the knowledge point A and the plurality of existing knowledge points B, C, D, . . . .

The search processing module 23b searches the knowledge point structure constructed under the user name and stored in the knowledge point storage module 22b for the relationship between the first knowledge point and the second knowledge point in the knowledge point structure corresponding to the user name, and returns a search result to the network terminal 1b by using the second transmission module 21b.

The display module 14b of the network terminal 1b displays the search result from the server 2b. If a corresponding relationship between the first knowledge point and the second knowledge point is retrieved, the display module 14b displays the following contents: a name of the relationship between the first knowledge point and the second knowledge point in the knowledge point structure constructed under the user name, contents of the first knowledge point in the knowledge point structure constructed under the user name, and contents the second knowledge point in the knowledge point structure constructed under the user name.

Preferably, a search result sequencing unit configured to perform sequencing processing on the search result may be further disposed in the search processing module of the server, for example, perform sequencing according to the number of searches or the number of clicks.

After reading the search result of the relationship between the knowledge points on the screen of the network terminal, the user may click the name of the relationship, to obtain content of the knowledge points defined in the relationship.

### Third Embodiment of a Knowledge Point-Based Multi-Criteria Search Apparatus

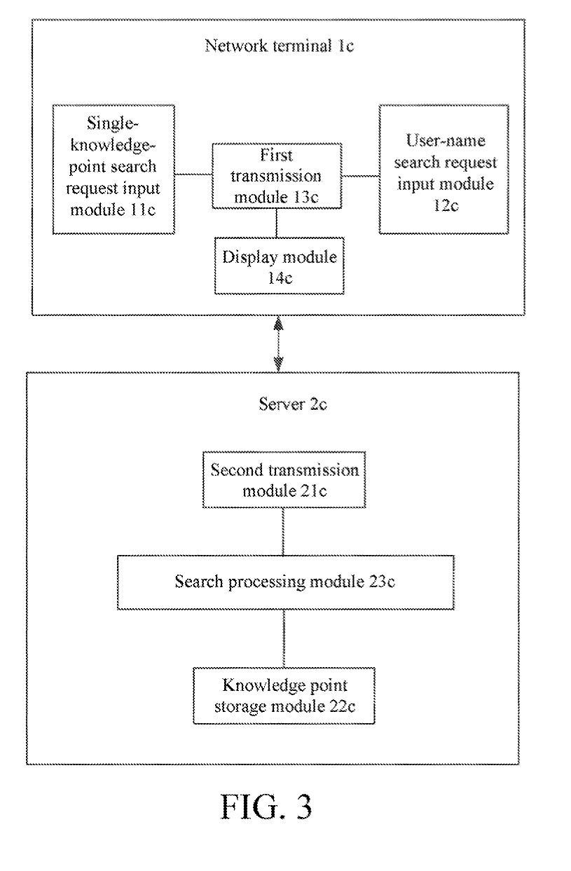

FIG. 3 shows the third embodiment of the knowledge point-based multi-criteria search apparatus consistent with the present invention. Referring to FIG. 3, the knowledge point-based multi-criteria search apparatus in this embodiment comprises: a network terminal 1c and a server 2c.

The network terminal 1c comprises a first search request input module (referred to as a single-knowledge-point search request input module 11c), a second search request input module (referred to as a user-name search request input module 12c), a first transmission module 13c, and a display module 14c.

The single-knowledge-point search request input module 11c receives a single knowledge point entered by a user. A specific implementation may be displaying a search bar on a display screen of the network terminal, for the user to enter the single knowledge point. The user-name search request input module 12c receives a user name entered by the user to which a knowledge point structure belongs. A specific implementation may be displaying another search bar on the display screen of the network terminal, for the user to enter a user name that the user wants to search. A search request for content that is of the single knowledge point entered by the user and that is in the knowledge point structure corresponding to the user name is uploaded to the server 2c by using the first transmission module 13c.

The server 2c comprises a second transmission module 21c, a knowledge point storage module 22c, and a search processing module 23c. The server 2c receives the search request from the network terminal by using the second transmission module 21c, and the knowledge point storage module 22c stores knowledge point structures constructed by users. The knowledge point storage module 22c stores a category, a structural relationship, a label, and content of a knowledge point. The category of the knowledge point refers to a category defined for the knowledge point by an editor of the knowledge point. For example, a user A defines “Belt and Road” into an “economy” category during editing, but a user B may define it into a “politics” category during editing. Different users have different understandings about a same knowledge point, and therefore may define it into different categories.

The label of the knowledge point is similar to a name of the knowledge point. For example, “Belt and Road” is a label of this knowledge point. The content of the knowledge point is a specific definition of the knowledge point. For example, a specific meaning of the Belt and Road is content under the label of “Belt and Road”.

The structural relationship of the knowledge point refers to a logical relationship between knowledge points, and this logical relationship may be preferably expressed by using a data structure in a tree form. A hyponymy relationship between knowledge points is expressed by using parent and child nodes, and a parallel relationship between knowledge points is expressed by using brother nodes. For example, a parent node of “Belt and Road” is “National Strategy”, child nodes of “Belt and Road” are “Silk Road Economic Belt”, “Maritime Silk Road”, and “Asian Infrastructure Investment Bank”, and brother nodes of “Belt and Road” are “Beijing-Tianjin-HebeiIntegration”, “Yangtze River Economic Belt”, “Free Trade Zone”, “Western Region Development”, “Revitalization of the Northeast”, and the like.

When an editor enters a knowledge point, in addition to content of the knowledge point, the editor further enters a relationship between the knowledge point and other knowledge points. For example, for a knowledge point A currently entered and an existing knowledge point B, a relationship between the knowledge point A and the knowledge point B may be entered when the knowledge point A is entered, which may be classified into: no relationship exists between A and B, or a parallel relationship exists between A and B. If a parallel relationship exists between A and B, it indicates that granularities of the knowledge points A and B are the same. The parallel relationship may be further classified into three categories: a causal relationship, no causal relationship but with a learning sequence, and no causal relationship and no learning sequence.

Similarly, no relationship or a parallel relationship (the parallel relationship is further classified into three categories: a causal relationship, no causal relationship but with a learning sequence, and no causal relationship and no learning sequence) exists between the knowledge point A currently entered and a plurality of existing knowledge points B, C, D, . . . . In addition, there is an implication/affiliation relationship between the knowledge point A and the plurality of existing knowledge points B, C, D, . . . .

The search processing module 23c searches the knowledge point structure constructed under the user name and stored in the knowledge point storage module 22c for the content of the single knowledge point in the knowledge point structure corresponding to the user name, and returns a search result to the network terminal 1c by using the second transmission module 21c.

The display module 14c of the network terminal 1c displays the search result from the server 2c. If the content of the single knowledge point is retrieved, the display module 14c displays the following contents: a label and the content of the single knowledge point in the knowledge point structure constructed by the user name.

### Embodiment of a Knowledge Point-Based Search Apparatus

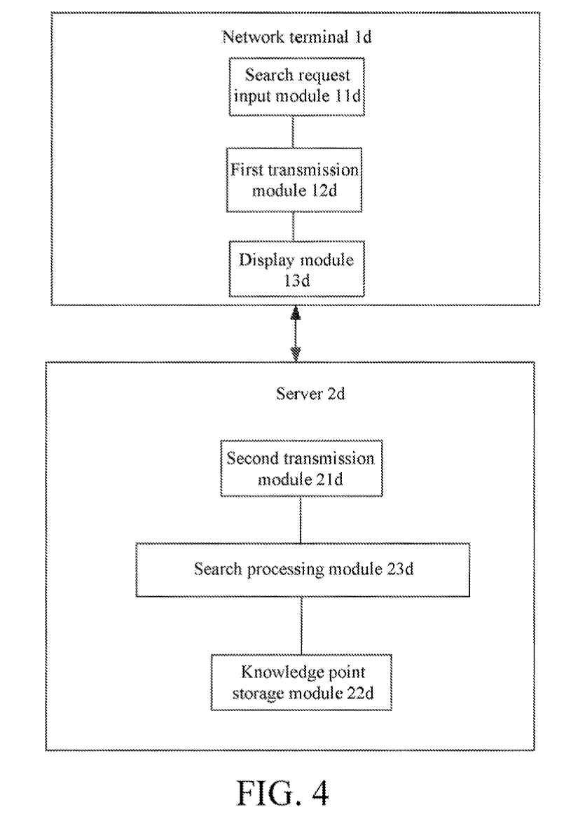

FIG. 4 shows a preferred embodiment of the knowledge point-based search apparatus consistent with the present invention. Referring to FIG. 4, the knowledge point-based multi-criteria search apparatus in this embodiment comprises: a network terminal 1d and a server 2d.

The network terminal 1d comprises a search request input module 11d, a first transmission module 12d, and a display module 13d.

The search request input module 11d receives a user name entered by a user to which a knowledge point structure belongs. This search request is uploaded to the server 2d by using the first transmission module 12d.

The server 2d comprises a second transmission module 21d, a knowledge point storage module 22d, and a search processing module 23d. The server 2d receives a search request from the network terminal by using the second transmission module 21d, and the knowledge point storage module 22d stores knowledge point structures constructed by users. The knowledge point storage module 22d stores a category, a structural relationship, a label, and content of a knowledge point. The category of the knowledge point refers to a category defined for the knowledge point by an editor of the knowledge point. For example, a user A defines“Belt and Road” into an “economy” category during editing, but a user B may define it into a “politics” category during editing. Different users have different understandings about a same knowledge point, and therefore may define it into different categories.

The label of the knowledge point is similar to a name of the knowledge point.

For example, “Belt and Road” is a label of this knowledge point. The content of the knowledge point is a specific definition of the knowledge point. For example, a specific meaning of the Belt and Road is content under the label of “Belt and Road”.

The structural relationship of the knowledge point refers to a logical relationship between knowledge points, and this logical relationship may be preferably expressed by using a data structure in a tree form. A hyponymy relationship between knowledge points is expressed by using parent and child nodes, and a parallel relationship between knowledge points is expressed by using brother nodes. For example, a parent node of “Belt and Road” is “National Strategy”, child nodes of “Belt and Road” are “Silk Road Economic Belt”, “Maritime Silk Road”, and “Asian Infrastructure Investment Bank”, and brother nodes of “Belt and Road” are “Beijing-Tianjin-HebeiIntegration”, “Yangtze River Economic Belt”, “Free Trade Zone”, “Western Region Development”, “Revitalization of the Northeast”, and the like.

When an editor enters a knowledge point, in addition to content of the knowledge point, the editor further enters a relationship between the knowledge point and other knowledge points. For example, for a knowledge point A currently entered and an existing knowledge point B, a relationship between the knowledge point A and the knowledge point B may be entered when the knowledge point A is entered, which may be classified into: no relationship exists between A and B, or a parallel relationship exists between A and B. If a parallel relationship exists between A and B, it indicates that granularities of the knowledge points A and B are the same. The parallel relationship may be further classified into three categories: a causal relationship, no causal relationship but with a learning sequence, and no causal relationship and no learning sequence.

Similarly, no relationship or a parallel relationship (the parallel relationship is further classified into three categories: a causal relationship, no causal relationship but with a learning sequence, and no causal relationship and no learning sequence) exists between the knowledge point A currently entered and a plurality of existing knowledge points B, C, D, . . . . In addition, there is an implication/affiliation relationship between the knowledge point A and the plurality of existing knowledge points B, C, D, . . . .

The search processing module 23d searches the entire knowledge point structure corresponding to the user name, and returns a search result to the network terminal 1d by using the second transmission module 21d.

The display module 13d of the network terminal 1d displays the search result from the server 2d, and displays the following contents: the entire knowledge point structure corresponding to the user name. If the entire knowledge point structure is very complex, a local area in the knowledge point structure may be extracted as the search result according to a preset rule by using a local structure extraction unit 231d in the search processing module 23d, and the search result is returned to the network terminal 1d by using the second transmission module 21d. For example, this preset rule is that the local area is a structural area most frequently clicked or added to favorites.

A person skilled in the art may be further aware that, various explanatory logical plates, modules, circuits, and algorithm steps described with reference to the embodiments disclosed in this specification may be implemented as electronic hardware, computer software, or a combination thereof. To clearly describe the interchangeability between the hardware and the software, various explanatory components, frames, modules, circuits, and steps are generally described in the foregoing in a form of functionality thereof. Whether this type of functionality is implemented as hardware or software depends on a specific application and a design constraint that is applied to an entire system. The skilled person may use different manners to implement the described functionality for each particular application, but the decision made shall not be construed as departing from the scope of the present invention.

The various explanatory logical plates, modules, and circuits described with reference to the embodiments disclosed in this specification may be implemented or executed by using a general processor, a digital signal processor (DSP), an application-specific integrated circuit (ASIC), a field-programmable gate array (FPGA), or another programmable logic device, a discrete gate or transistor logic, a discrete hardware component, or any combination designed to perform the functions described in this specification. The general processor may be a microprocessor, but in an alternative solution, the processor may be any common processor, controller, micro-controller, or state machine. The processor may be further implemented as a combination of computing devices, for example, a combination of the DSP and the microprocessor, a plurality of microprocessors, one or more microprocessors cooperating with a DSP core, or any other configuration of this type.

The steps of the method or algorithm described with reference to the embodiments disclosed in this specification may be embodied directly in hardware, in a software module executed by a processor, or in a combination thereof. The software module may reside in a RAM, a flash memory, a ROM, an EPROM, an EEPROM, a register, a hard disk, a removable disk, a CD-ROM, or a storage medium of any other form known in the art. An exemplary storage medium is coupled to a processor, to enable the processor to read data from and write data into the storage medium. In an alternative solution, the storage medium may be integrated into the processor. The processor and the storage medium may reside in an ASIC. The ASIC may be resident in a user terminal. In the alternative solution, the processor and the storage medium may reside in the user terminal as discrete components.

In one or more exemplary embodiments, the described functions may be implemented in hardware, software, firmware, or any combination thereof. If the functions are implemented in the software as computer program products, the functions may be stored in a computer-readable medium as one or more instructions or code, or transmitted by using the computer-readable medium. The computer readable medium comprises a computer storage medium and a communications medium, and comprises any medium that facilitates transmission of a computer program from one place to another place. The storage medium may be any available medium that can be accessed by a computer. As an example but not a limitation, such computer readable medium may comprise a RAM, a ROM, an EEPROM, a CD-ROM, or another optical disc storage or magnetic disk storage device, or another magnetic storage device, or any other mediums that can carry or store expected program code in a form of an instruction or a data structure and can be accessed by the computer. Any connection is properly referred to as a computer-readable medium. For example, if software is transmitted from a website, a server, or another remote source by using a coaxial cable, an optical fiber cable, a twisted pair, a digital subscriber line (DSL), or a radio technology such as infrared, radio, or microwave, the coaxial cable, the optical fiber cable, the twisted pair, the DSL, or the radio technology such as infrared ray, radio, or microwave is comprised in a definition of the medium. For example, disks and discs used in this specification comprise a compact disc (CD), a laser disc, an optical disc, a digital versatile disc (DVD), a floppy disk, and a Blu-ray disc, where the disks reproduce data by a magnetic laser means, and the discs reproduce data in an optical manner by a laser means. The foregoing combination should also be comprised in the scope of computer-readable mediums.

The prior descriptions of the present disclosure are provided, so that any person skilled in the can to produce or use the present disclosure. Various modifications to the present disclosure are obvious to a person skilled in the art. In addition, a universal principle defined in this specification may be applied to another variant without departing from the spirit or scope of the present disclosure. Therefore, the present disclosure is not intended to be limited to the examples and designs described in this specification, but should fall within the largest scope that is consistent with the principles and novel characteristics disclosed in this specification.

1. A knowledge point-based multi-criteria search apparatus, comprising a network terminal and a server, wherein
the network terminal comprises:
a first search request input module, receiving a first knowledge point entered by a user;
a second search request input module, receiving a second knowledge point entered by the user;
a first transmission module, transmitting data to the server; and
a display module, displaying a search result from the server; and
the server comprises:
a second transmission module, transmitting data to the network terminal;
a knowledge point storage module, storing knowledge point structures constructed by users; and
a search processing module, searching, based on the first knowledge point and the second knowledge point uploaded by the network terminal, the knowledge point structures constructed by the users and stored in the knowledge point storage module for a relationship between the first knowledge point and the second knowledge point, and returning the search result to the network terminal by using the second transmission module.

2. The knowledge point-based multi-criteria search apparatus according to claim 1, wherein contents of the search result displayed by the display module comprises: a name of the relationship between the first knowledge point and the second knowledge point in all the knowledge point structures, contents of the first knowledge point in all the knowledge point structures, and contents of the second knowledge point in all the knowledge point structures.

3. The knowledge point-based multi-criteria search apparatus according to claim 1, wherein the network terminal further comprises:
a third search request input module, receiving a user name entered by the user to which a knowledge point structure belongs; and
a search processing module, searching, based on the first knowledge point and the second knowledge point uploaded by the network terminal and the user name to which the knowledge point structure belongs, the knowledge point structure corresponding to the user name for the relationship between the first knowledge point and the second knowledge point, and returning the search result to the network terminal by using the second transmission module.

4. The knowledge point-based multi-criteria search apparatus according to claim 3, wherein contents of the search result displayed by the display module comprises: a name of the relationship between the first knowledge point and the second knowledge point in the knowledge point structure corresponding to the user name, contents of the first knowledge point in the knowledge point structure corresponding to the user name, and contents of the second knowledge point in the knowledge point structure corresponding to the user name.

5. The knowledge point-based multi-criteria search apparatus according to claim 1, wherein the search processing module further comprises:
a search result sequencing unit, performing sequencing processing on the search result.

6. A knowledge point-based multi-criteria search apparatus, comprising a network terminal and a server, wherein
the network terminal comprises:
a first search request input module, receiving a knowledge point entered by a user;
a second search request input module, receiving a user name entered by the user to which a knowledge point structure belongs;
a first transmission module, transmitting data to the server; and
a display module, displaying a search result from the server; and
the server comprises:
a second transmission module, transmitting data to the network terminal;
a knowledge point storage module, storing knowledge point structures constructed by users; and
a search processing module, searching, based on the knowledge point uploaded by the network terminal, the knowledge point structure constructed under the user name and stored in the knowledge point storage module for content of the knowledge point, and returning the search result to the network terminal by using the second transmission module.

7. A knowledge point-based search apparatus, comprising a network terminal and a server, wherein
the network terminal comprises:
a search request input module, receiving a user name entered by a user to which a knowledge point structure belongs;
a first transmission module, transmitting data to the server; and
a display module, displaying a search result from the server; and
the server comprises:
a second transmission module, transmitting data to the network terminal;
a knowledge point storage module, storing knowledge point structures constructed by users; and
a search processing module, searching the knowledge point structure constructed under the user name, and returning the search result to the network terminal by using the second transmission module.

8. The knowledge point-based search apparatus according to claim 7, wherein the search processing module further comprises:
a local structure extraction unit, extracting a local area in the knowledge point structure as the search result according to a preset rule, and returning the search result to the network terminal by using the second transmission module.
